(19) United States
(12) Patent Application Publication
(10) Pub. No.: US 2008/0022638 A1
(43) Pub. Date: Jan. 31, 2008

(54) CONTOURED CONSTRUCTION FOR IMPROVED FIT IN HORSE BRIDLES

(76) Inventor: Eva Charlene Sandor, Chicago, IL (US)

Correspondence Address: EVA SANDOR, 405 NORTH WABASH, UNIT 111, CHICAGO, IL, 60611, US

(21) Appl. No.: 11/459,839

(22) Filed: Jul. 25, 2006

(51) Int. Cl. B68B 1/06

(52) U.S. Cl. 54/8

(57) ABSTRACT

A bridle for horses which alleviates the problem of poor fit often encountered in conventional bridles. This invention shows a way in which bridles may be constructed so that their fit is improved, taking into account the various curvatures, dimensions and features of a horse's head and removing a potential source of irritation or distraction to the animal. The invention enhances the comfort of the horse and thus the safety of the rider.

### CROSS-REFERENCE TO RELATED APPLICATIONS

Not applicable.

### BACKGROUND OF THE INVENTION

When riding a horse, perhaps the most important piece of equipment is a bridle: this is the apparatus which holds a bit in place in a horse's mouth. It is by means of a bit, and its attached reins, that the rider stops, steers and otherwise communicates with his mount.

However, despite great advances in the design of other pieces of horse riding equipment, bridles have remained unsophisticated in terms of fit.

The parts of which a conventional bridle is composed are cut as flat straps of material whose long edges are parallel to one another. When fastened, these encircle a cylinder without difficulty. However. the head of a horse is not perfectly cylindrical. Rather, it is shaped somewhat like a cone with flattened sides, broadest between the eyes and tapering toward the muzzle. In addition, a horse's head has several sensitive prominences including the cheekbones, the bones of the temples, the orbits of the eyes, and the bases of the ears.

Because it is not specifically designed to take the shape of a horse's head into account, a conventional bridle may rub against parts of a horse's face and so cause physical irritation, distraction or annoyance to the animal; in addition, on a conventional bridle, a poorly fitting browband may pull other bridle parts forward, thus interfering with a horse's vision.

An improvement in bridle fit would enhance the comfort of the horse, and thus the safety of the rider, by removing a potential source of irritation or distraction. It is the purpose of this invention to show a way in which bridles may be constructed so as to improve their fit.

In the past, other patents have been awarded for improvements in bridle construction and function. However, they have made different claims and have had a different objective than this invention.

U.S. Pat. No. 6,662,536, “Pressure Relieving Bridle” (Belton et al.) describes a configuration of straps which, in conjunction with a cushioning pad, provides relief from the pressure which a bridle places on the crown of a horse's head. However, U.S. Pat. No. 6,662,536 does not mention, describe, or claim any improvement in the shape of any conventional bridle part.

U.S. Pat. No. 6,691,497, “Humane Horse Headgear” (Rodgers) describes a bridle made with insets of “an elasticated material . . . a contoured crown piece . . . [is] also disclosed”. However, the purpose of the elasticated, contoured crown piece in U.S. Pat. No. 6,691,497 was to “provide a load-bearing surface”. It was not claimed to have the benefit of preventing a poorly fitting bridle from pulling forward, as does a bridle according to this invention.

### BRIEF SUMMARY OF THE INVENTION

It is the object of this invention to describe a new pattern for shapes for the constituent parts of a bridle, which when assembled will allow it to better follow the contours of a typical horse's head.

In accordance with this invention, the constituent parts of a bridle should not be cut as flat straps of material whose long edges are parallel to one another. Rather, they should be cut as contoured parts which, when sewn, buckled, or otherwise assembled into the finished arrangement of a bridle, create a fit which takes into account the conical shape of a horse's nose and jaw; the slope of a horse's forehead; the bones of a horse's temples; the orbits of a horse's eyes; the bases of a horse's ears; and other dimensions and curvatures of a typical horse's head.

There will now be given detailed descriptions, to be read with reference to the accompanying drawings, of a conventional bridle in both its assembled and disassembled states, and detailed views, on a larger scale, of those parts of a conventional bridle which typically show an imperfect fit for the horse's head.

In addition, there will now be given as detailed descriptions, to be read with reference to the accompanying drawings, of a bridle in accordance with this invention in both its assembled and disassembled states; and detailed views, on a larger scale, of those parts of a bridle in accordance with this invention which demonstrate the invention's improved fit for the horse's head.

### BRIEF DESCRIPTION OF THE SEVERAL VIEWS OF THE DRAWING

FIG. 1 is a schematic perspective view of a conventional bridle;

FIG. 2 is a view of the parts of a conventional bridle, disassembled and laid flat;

FIG. 3 is a schematic perspective view depicting how a conventional bridle typically shows an imperfect fit for a horse's head;

FIG. 4 is a detailed view, on a larger scale, of how a browband (11) of a conventional bridle typically shows an imperfect fit;

FIG. 5 is a detailed view, on a larger scale, of how a noseband strap (13) and bit hanger (16) of a conventional bridle typically show an imperfect fit;

FIG. 6 is a detailed view, on a larger scale, of how a noseband (12) of a conventional bridle typically shows an imperfect fit.

FIG. 7 is a schematic perspective view of a bridle in accordance with this invention;

FIG. 8 is a view of the parts of a bridle in accordance with this invention, disassembled and laid flat;

FIG. 9 is a schematic perspective view depicting how a bridle in accordance with this invention will show an improved fit for a horse's head;

FIG. 10 is a detailed view, on a larger scale, of how a browband (11) of a bridle in accordance with this invention will show an improved fit for a horse's head;

FIG. 11 is a detailed view, on a larger scale, of how a noseband strap (13) and bit hanger (16) of a bridle in accordance with this invention will show an improved fit for a horse's head;

FIG. 12 is a detailed view, on a larger scale, of how a noseband (12) of a bridle in accordance with this invention will show an improved fit for a horse's head.

### DETAILED DESCRIPTION OF THE INVENTION

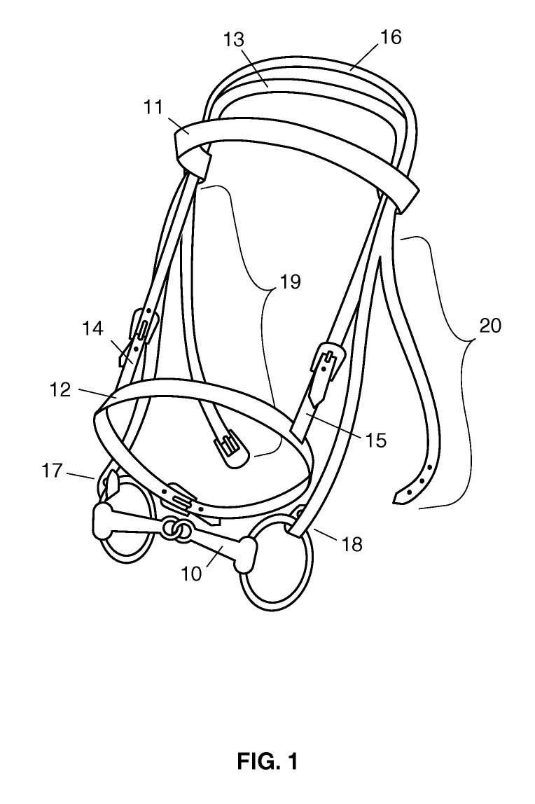

FIG. 1 shows a conventional bridle. Such a bridle typically comprises a noseband (12), whose distal ends are attached to one another by means of a fastener and which, when so fastened, forms a loop encircling the horse's nose and jaw. To this noseband, two noseband cheekpieces (14) and (15) are attached, which lie alongside the horse's left and right cheeks respectively. A noseband headpiece (13) passes around the horse's head behind its ears, is threaded through the looped ends of a browband (11), and is then connected by means of fasteners to a left cheekpiece (14) and right cheekpiece (15), thus securing the noseband (12) in its position encircling the horse's nose and jaw. The traditional purpose of such an assembly is twofold: first, to prevent the horse from opening its mouth to avoid the action of the bit; and second, to provide a point to which one may fasten a martingale or other attachment.

A bridle typically further comprises a bit hanger (16) which passes around the horse's head behind its ears, is threaded through the looped ends of the browband (11), and is fastened to a bit (10) at its right fastener end (17) and left fastener end (18), thus securing the bit in position within the horse's mouth. A bit hanger (16) also comprises two rear portions, which are together known as the throatlash. The fastener side of the throatlash (19) connects by means of a fastener to the adjustment side of the throatlash (20) and together these parts encircle the horse's throat. The traditional purpose of such an assembly is twofold: first, to secure the bit in position within the horse's mouth; and second, to secure the entire bridle upon the horse's head.

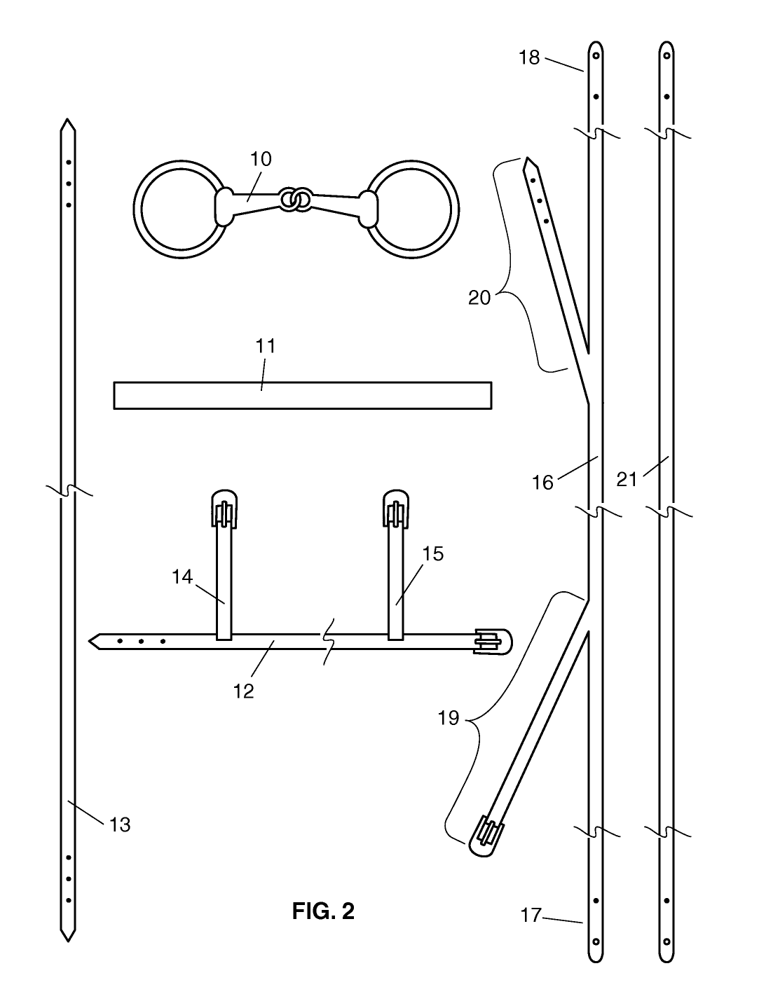

At certain times, riders may wish to use two bits in the horse's mouth. Should the rider wish to use a second bit, the bridle shown in FIG. 1 may be used with the addition of a second bit hanger (FIG. 2, 21) which is identical to the first with the exception that it lacks a throatlash.

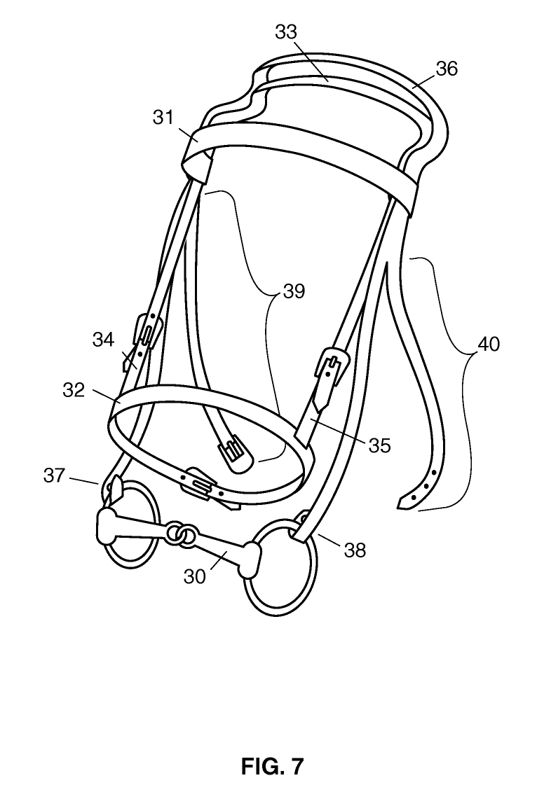

FIG. 7 shows the parts of a bridle in accordance with this invention. The parts of a bridle in accordance with this invention are the same in number and purpose as the parts of a conventional bridle. They are the noseband (32), two noseband cheekpieces (34) and (35), a browband (31), a noseband headpiece (33), a bit hanger (36) with right fastener end (37) and left fastener end (38) connected to a bit (30), and a throatlash consisting of a fastener side (39) and an adjustment side (40).

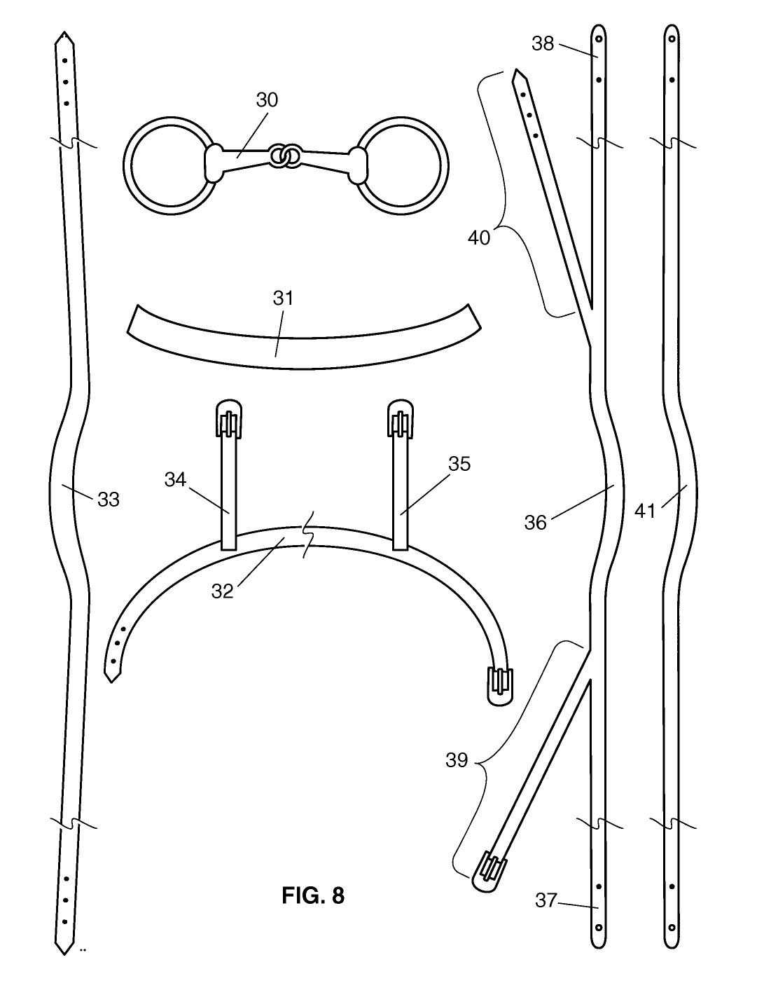

At certain times, riders may wish to use two bits in the horse's mouth. Should the rider wish to use a second bit, the bridle shown in FIG. 7 may be used with the addition of a second bit hanger (FIG. 8, 41) which is identical to the first with the exception that it lacks a throatlash.

The purpose and claim of this invention, however, is not the number, purpose or arrangement of the bridle parts. It is rather the specific shape of the parts themselves.

FIG. 2 shows the constituent parts of a conventional bridle, disassembled and laid flat. They are a noseband (12), two noseband cheekpieces (14) and (15), a browband (11), a noseband headpiece (13), a bit hanger (16) with right fastener end (17) and left fastener end (18) connected to a bit (10), and a throatlash consisting of a fastener side (19) and an adjustment side (20).

It can clearly be seen that all parts of the conventional bridle are cut as flat straps whose long sides are parallel to one another. While this configuration of parts provides maximum economy in terms of the amount of material used to make a bridle, it has serious drawbacks in terms of fit.

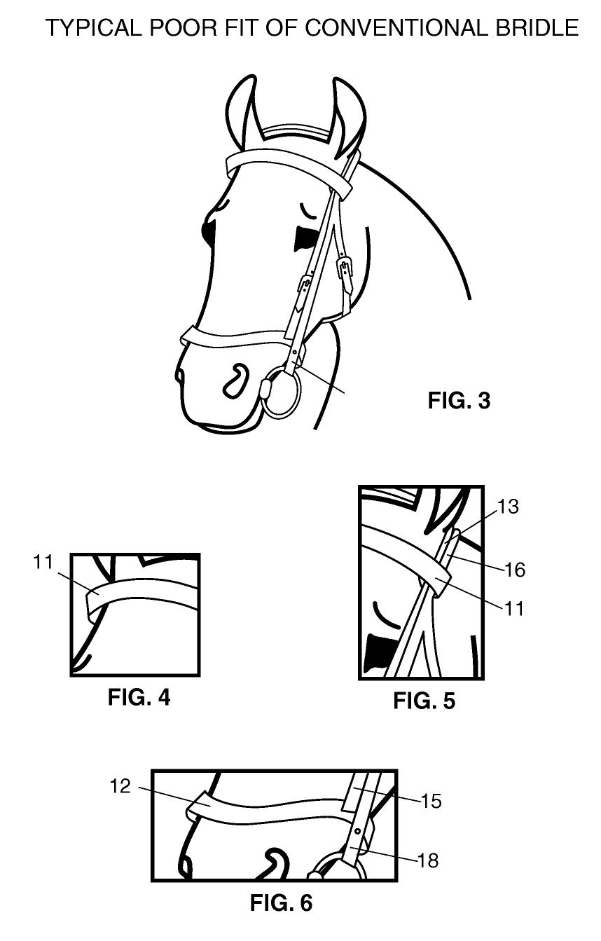

FIG. 3 shows the typical poor fit of a conventional bridle.

FIG. 4 is a detailed view, on a larger scale, of how the browband (11) of a conventional bridle typically shows an imperfect fit, failing to follow the curvature of the horse's forehead. This can create a situation where the browband pinches, rubs or droops across the horse's forehead, annoying or distracting the animal.

FIG. 5 is a detailed view, on a larger scale, of how the headpiece (13) and bit hanger (16) of a conventional bridle typically show an imperfect fit, failing to follow the curvature of the base of a horse's ears. The ears are a particularly sensitive part of the horse's body and are often cut into, pinched or rubbed by the headpiece (13) and bit hanger (16); furthermore, the poor fit of these parts can pull the browband (11) forward, thus causing the sides of the noseband headpiece (33) and bit hanger (36) to pass uncomfortably close to a horse's eyes.

FIG. 6 is a detailed view, on a larger scale, of how the noseband (12) of a conventional bridle typically shows an imperfect fit, failing to follow the conical shape of a horse's nose and jaw. This can create a situation where the noseband droops or rubs across a horse's nose or passes at an oblique angle around a horse's jaw, thus annoying or distracting the animal.

FIG. 8 shows the constituent parts of a bridle in accordance with this invention, disassembled and laid flat. They are a noseband (32), two noseband cheekpieces (34) and (35), a browband (31), a noseband headpiece (33), a bit hanger (36) with right fastener end (37) and left fastener end (38) connected to the bit (30), and a throatlash consisting of a fastener side (39) and an adjustment side (40).

It can clearly be seen that the parts of a bridle in accordance with this invention are curved in various ways. This configuration of parts creates a fit which takes into account the slope of a horse's forehead; the bases of the horse's ears; the conical shape of a horse's nose and jaw; and other dimensions and curvatures of a horse's head.

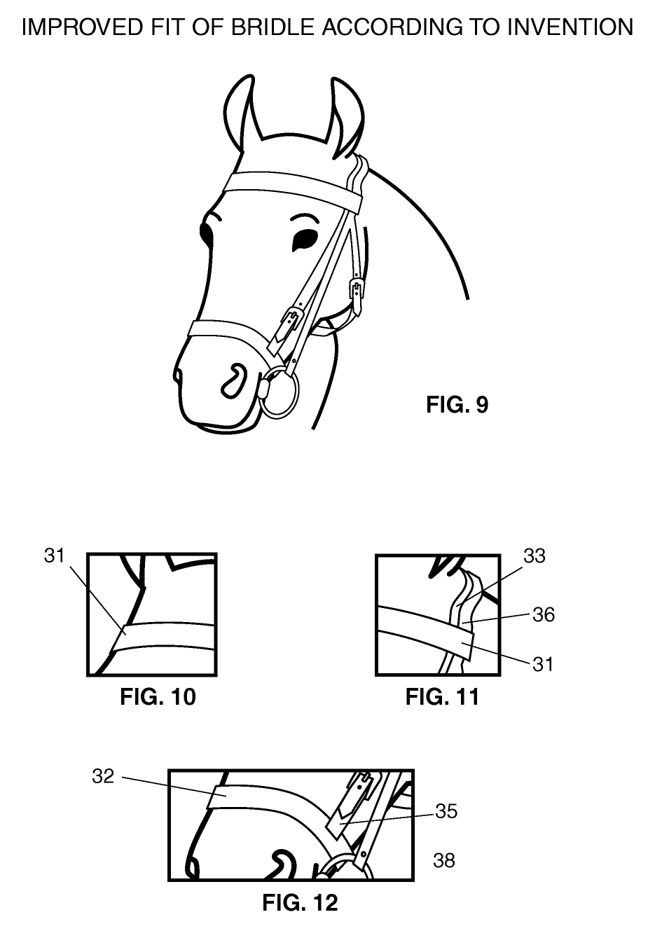

FIG. 9 shows the improved fit of a bridle in accordance with this invention.

FIG. 10 is a detailed view, on a larger scale, of how the browband (31) of a bridle in accordance with this invention shows an improved fit, following the curvature of a horse's forehead.

FIG. 11 is a detailed view, on a larger scale, of how the noseband headpiece (33) and bit hanger (36) of a bridle in accordance with this invention show an improved fit, following the curvature of the base of the horse's ears. Furthermore, the improved fit of these parts do not pull the browband (31) forward.

FIG. 12 is a detailed view, on a larger scale, of how the noseband (32) of a bridle in accordance with this invention shows an improved fit, following the conical shape of a horse's nose and jaw.

A bridle in accordance with this invention may be realized by means of diverse manufacturing methods, sizes and designs. The materials of which a bridle in accordance with this invention is made, as well as the particular types of fasteners used in attaching its constituent parts to one another, bits, reins, or any other attachments, are irrelevant for the purpose of this invention.

The required curvature of bridle parts may be achieved by various means. Any bridle shaped in accordance with the following claims may be considered a bridle in accordance with this invention.

1. A bridle for use over a horse's head comprising a noseband, a noseband headpiece, two noseband cheekpieces, a browband, a bit hanger having a right fastener end and a left fastener end each of which is connected to a bit, and a throatlash having a fastener side and an adjustment side, which takes into account the various curvatures, dimensions and features of a horse's head.

2. A bridle in accordance with claim 1 wherein the bridle parts are cut from the bridle material, or are shaped by means of darts, or are molded or cast from a formable material, in such shapes as to take into account the various curvatures, dimensions and features of a horse's head.

3. A bridle part which is cut from the bridle material in the form of an arc; or is shaped by means of darts, or is molded or cast from a formable material, in such a shape as to assume the form of an arc when laid flat.

4. A bridle part which is cut from the bridle material, or is shaped by means of darts, or molded or cast from a formable material, in such a shape as to take into account the various curvatures, dimensions and features of a horse's head.

5. A bridle in accordance with claim 3 wherein the noseband is cut from the bridle material in the form of an arc; or is shaped by means of darts, or molded or cast from a formable material, in such a shape as to assume the form of an arc when laid flat.

6. A bridle in accordance with claim 4 wherein the noseband headpiece is cut from the bridle material, or is shaped by means of darts, or molded or cast from a formable material, in such a shape as to curve comfortably around the base of a horse's ears.

7. A bridle in accordance with claim 4 wherein the noseband headpiece is cut from the bridle material, or is shaped by means of darts, or molded or cast from a formable material, in such a shape as to lie where it does not interfere with a horse's eyes.

8. A bridle in accordance with claim 4 wherein the noseband headpiece is cut from the bridle material, or is shaped by means of darts, or molded or cast from a formable material, in such a shape as to allow the noseband cheekpieces to lie where they do not interfere with a horse's eyes.

9. A bridle in accordance with claim 3 whose browband is designed as a shape which, when assembled into the finished form of a bridle, takes into account the sloping shape of a horse's forehead.

10. A bridle in accordance with claim 3 wherein the browband is cut from the bridle material in the form of an arc; or is shaped by means of darts, or molded or cast from a formable material, in such a shape as to assume the form of an arc when laid flat.

11. A bridle in accordance with claim 3 wherein the browband is cut from the bridle material, or is shaped by means of darts, or molded or cast from a formable material, in such a shape as to allow the cheekpieces which pass through it to lie comfortably behind a horse's ears, without being pulled forward by the browband into a position where they might interfere with the horse's ears.

12. A bridle in accordance with claim 3 wherein the browband is cut from the bridle material, or is shaped by means of darts, or molded or cast from a formable material, in such a shape as to allow the cheekpieces which pass through it to lie comfortably along a horse's cheeks without being pulled forward by the browband into a position where they might interfere with the horse's eyes.

13. A bridle in accordance with claim 3 wherein the browband is cut from the bridle material, or is shaped by means of darts, or molded or cast from a formable material, in such a shape as to allow the bit hanger which passes through it to lie comfortably behind a horse's ears, without being pulled forward by the browband into a position where they might interfere with the horse's ears.

14. A bridle in accordance with claim 3 wherein the browband is cut from the bridle material, or is shaped by means of darts, or molded or cast from a formable material, in such a shape as to allow the bit hanger which passes through it to lie comfortably along a horse's cheeks without being pulled forward by the browband into a position where they might interfere with the horse's eyes.

15. A bridle in accordance with claim 4 whose bit hanger is designed as a shape which, when assembled into the finished form of a bridle, takes into account the various curvatures, dimensions and features of a horse's head.

16. A bridle in accordance with claim 4 wherein the bit hanger is cut from the bridle material in such a shape, or is shaped by means of darts, or is molded or cast from a formable material, in such a shape as to curve around the base of a horse's ears, thus making certain that it does not interfere with the horse's ears.

17. A bridle in accordance with claim 4 wherein the bit hanger is cut from the bridle material, or is shaped by means of darts, or molded or cast from a formable material, in such a shape as to allow it to lie comfortably along a horse's cheeks, where it does not interfere with the horse's eyes.

18. A bridle in accordance with claim 4 wherein any additional bit hanger or hangers are designed as shapes which, when assembled into the finished form of a bridle, take into account the various curvatures, dimensions and features of a horse's head.

19. A bridle in accordance with claim 4 wherein any additional bit hanger or hangers are cut from the bridle material in such a shape, or are shaped by means of darts, or is molded or cast from a formable material, in such shapes as to curve around the base of a horse's ears, thus making certain that they do not interfere with the horse's ears.

20. A bridle in accordance with claim 4 wherein any additional bit hanger or hangers are cut from the bridle material, or are shaped by means of darts, or are molded or cast from a formable material, in such shapes as to allow them to lie comfortably along a horse's cheeks, where they do not interfere with the horse's eyes.
